(19) United States
(12) Patent Application Publication
(10) Pub. No.: US 2026/0062514 A1
(43) Pub. Date: Mar. 5, 2026

(54) METHODS OF PREPARING ULTRA-LOW DENSITY SPRAY POLYURETHANE FOAM AND USES THEREOF

(71) Applicant: General Coatings Manufacturing Corp., Santa Fe Springs, CA (US)

(72) Inventors: Mayank Pratap Singh, Santa Fe Springs, CA (US); Roger Edmund Ervast, Santa Fe Springs, CA (US); Ashish N. Dhuldhoya, Santa Fe Springs, CA (US); Kaushal Maheshbhai Patel, Santa Fe Springs, CA (US); Yash Hitesh Patel, Santa Fe Springs, CA (US)

(21) Appl. No.: 19/309,402

(22) Filed: Aug. 25, 2025

Related U.S. Application Data
(60) Provisional application No. 63/690,020, filed on Sep. 3, 2024.

(51) Int. Cl. C08G 71/04; C08K 3/016; C08K 5/06; C08K 5/31

(52) U.S. Cl. CPC C08G 71/04; C08K 3/016; C08K 5/06; C08K 5/31

(57) ABSTRACT

Open-cell spray polyurethane foams having low densities and high yields, methods for the manufacture thereof, and methods of use thereof are disclosed. A isocyanate mixture and a resin mixture comprising a polyol, an emulsifier, a flame retardant, a catalyst, a surfactant, and a blowing agent may be simultaneously applied to a substrate with a spraying system. If the isocyanate and resin mixtures are sprayed while the spraying system is in an environment having an ambient temperature ranging from 80 to 90 degrees Fahrenheit and a relative humidity of 30% or less, the resulting foam may have a density of 5 pounds per cubic foot or less and a yield of at least 15,000 board feet per 50 gallons. Such foams may also have various desirable physical characteristics similar to conventional closed-cell spray polyurethane foams, making these foams ideal for insulating buildings.

### CROSS-REFERENCE TO RELATED APPLICATIONS

This application relates to and claims the benefit of U.S. Provisional Application No. 63/690,020 filed Sep. 3, 2024, and entitled “METHOD OF PREPARING ULTRA-LOW-DENSITY SPRAY POLYURETHANE FOAM AND USING THEREOF,” the entire disclosure of which is hereby wholly incorporated by reference.

### STATEMENT RE: FEDERALLY SPONSORED RESEARCH/DEVELOPMENT

Not Applicable

### BACKGROUND

### 1. Field of Invention

The present application relates to methods of preparing and using spray polyurethane foams. More specifically, the present application relates to methods of preparing and using spray polyurethane foams having particularly low densities and high yields while having desirable physical characteristics.

### 2. Related Art

Various polyurethane-based products are known and used in the art. Such products can be manufactured via a chemical reaction between a polyol component and an isocyanate component, which can be facilitated by simultaneously applying those substances upon a substrate with a spraying system. Examples of polyurea-based composite structures and coatings are disclosed in U.S. Pat. No. 6,841,111, entitled “Method for making a polyurea composite structure substantially free of volatile organic compounds,” U.S. Pat. No. 7,001,948 entitled “Polyurea coating compositions”, and Applicant's previously filed U.S. patent application Ser. No. 18/514,861 entitled “Sprayed Multilayer Polyurea and Polyurethane Composites,” and Ser. No. 19/197,856 entitled “Composite Polyurea Structure and Method of Fabricating Same,” the entire disclosures of each of which are wholly incorporated herein by reference.

Another type of polyurea-based product is a spray polyurethane foam. Spray polyurethane foams are spray-applied cellular plastic foams which may act as an air sealant, a moisture barrier, a sound barrier, and an insulator. These properties render these foams ideal for installment in the walls of buildings, as the foam may protect the insides of those buildings from the external environment. Spray polyurethane foams are conventionally available as either closed-cell foams or open-cell foams. Closed-cell foams have superior insulation, moisture resistance, strength, rigidity, and sound absorption properties, while open-cell foams sacrifice the effectiveness of these properties for a lower density and more flexible product which can obtain a higher yield (coverage area per unit volume). The need to select one set of properties over the other leaves a lot to be desired, and prior attempts to make foams having all possible benefits have been unsuccessful. In particular, open cell spray polyurethane foams having densities of 0.5 pounds per cubit foot and R-values at 1 inch of at least 4 have been difficult to obtain. As such, there is a need in the art for high yield, low-density spray polyurethane foams which provide desirable levels of insulation, moisture/water resistance, and strength.

### BRIEF SUMMARY

To solve these and other problems, low-density, high-yield open-cell spray polyurethane foams are disclosed which may have various desirable physical properties characteristic of conventional closed-cell spray polyurethane foams. Such a foam may be produced by providing an isocyanate mixture comprising an isocyanate and a resin mixture comprising a polyol, a catalyst, an emulsifier, a flame retardant, and a blowing agent. Both of these mixtures can be simultaneously sprayed from their respective reservoirs with a spraying system in an environment having an ambient temperature ranging from 80 to 98 degrees Fahrenheit, more preferably 85 to 98 degrees Fahrenheit, and a relative humidity of 30% or less, more preferably a relative humidity ranging from 15% to 30%, such that the isocyanate mixture and resin mixture are applied upon a substrate to form an applied mixture. The applied mixture can be allowed to cure on the substrate; the resulting foam may have a low density of 0.5 pounds per cubic foot (pcf) or less, more ideally 0.45 pcf or less, or most ideally 0.4 pcf or less, and a yield of at least 15,000 board feet per 50 gallons of both isocyanate and resin mixtures, or at least 18,000 board feet per 50 gallons in more preferred embodiments, or at least 20,000 board feet per 50 gallons in most preferred embodiments.

The isocyanate mixture's isocyanate component may comprise methyl diphenyl diisocyanate (MDI) and could have a functionality ranging from 2.6 to 3.0. The resin mixture's polyol may comprise glycerin-based triols, sucrose-based triols, diethanolamine-based triols, or combinations thereof, and the total amount of polyol present in a resin mixture could range from 12 parts-by-weight to 18 parts-by-weight of the resin mixture. The emulsifier could comprise a nonylphenolethoxylate (NPE) and could be present in the resin mixture at a concentration ranging from 12 parts-by-weight to 20 parts-by-weight of the resin mixture. The flame retardant could be present in the resin mixture at a concentration ranging from 25 parts-by-weight to 30 parts-by-weight of the resin mixture, while the surfactant could be a silicone surfactant ranging from 0.4 parts-by-weight to 1 part-by-weight of the resin mixture. The resin mixture's blowing agent could be water and may range from 15 parts-by-weight to 20 parts-by-weight of the resin mixture.

The catalyst of the resin mixture could facilitate the reaction between the isocyanates, water, and polyol in the applied mixture and could comprise an amine, an organometallic complex, an organic acid salt of a metal, an alkali metal salt compound, an alkali metal, or combinations thereof. Examples of suitable amines include 2(2-Dimethylaminoethoxy)ethanol, N-Methyl-N—(N,N-dimethylaminoethyl)-aminoethanol, carboxylate salts of 1,1,3,3-tetramethylguanidine, 1,1,3,3-tetramethylguanidine, ethoxylamine, ethoxyldiamine, bis-(diethylethanolamine)adipate, 1,3,5-tris-(3-dimethylaminopropyl)-1,3,5-triazine, bis-(3-dimethylaminopropyl)methyl-amine, bis(2-dimethylamino ethyl)ether, triethylenediamine, N,N-dimethylcyclohexylamine, N-methylmorpholine, N,N′-diethyl-2-methylpiparazine, N,N′-bis-(2-hydroxypropyl)-2-methylpiparazine, bis(2,21-dimethylaminoethyl)ether, 1,8-diazabicycloundec-7-ene (DBU), and combinations thereof. Appropriate alkali metal salt compounds include, but are not limited to, potassium acetate, potassium octoate, alkali metal carboxylates, metal alcoholoates, metal phenolates, metal hydroxides, quaternary ammonium salts, and combinations thereof. The total amount of catalyst in a resin mixture may comprise 3.5 parts-by-weight to 11 parts-by-weight of the resin mixture. In preferred embodiments, the catalyst includes 1,1,3,3-tetramethylguanidine, one or more carboxylate salts of 1,1,3,3-tetramethylguanidine, or both at a concentration ranging from 0.2 parts-by-weight to 1 part-by-weight of the resin mixture.

The isocyanate mixture and resin mixture may each independently be sprayed from the spraying system, at a spraying pressure ranging from 800 psi to 1500 psi. When being sprayed from the spraying system, the resin mixture may be at a temperature ranging from 130 to 135 degrees Fahrenheit. The mixtures may be sprayed in a single pass such that the applied mixture has a thickness ranging from 2 to 6 inches, more preferably 3.5 to 6 inches. When cured, the spray polyurethane product may have a tensile strength of at least 3 psi, at least 4 psi, or at least 4.5 psi, and an R-value at 1 inch of at lest 3.5, or at least 4. Additionally, the foam may be effective at preventing intrusion of water/moisture, air, sound, and heat, and the foam could further have a low degree of flammability. Such properties may make this foam ideal when it becomes interposed between the external and internal walls of a building, as the foam may help to shield an internal environment defined by the building from the external environment surrounding the building.

All of these embodiments are contemplated to be within the scope of this disclosure. These and other embodiments will become readily apparent to those skilled in the art from the following detailed description of the preferred embodiments having reference to the attached figures, the disclosure not being limited to any particular preferred embodiment.

### BRIEF DESCRIPTION OF THE DRAWINGS

These and other features and advantages of the various embodiments disclosed herein will be better understood with respect to the following description and drawings, in which:

FIG. 1A shows the FOMAT rate of raise of a first working embodiment of a spray polyurethane foam according to this present disclosure;

FIG. 1B shows the FOMAT velocity plot of the first working embodiment of a spray polyurethane foam according to this present disclosure;

FIG. 2A shows the FOMAT rate of raise of a second working embodiment of a spray polyurethane foam according to this present disclosure;

FIG. 2B shows the FOMAT velocity plot of the second working embodiment of a spray polyurethane foam according to this present disclosure;

FIG. 3A shows the FOMAT rate of raise of a third working embodiment of a spray polyurethane foam according to this present disclosure; and

FIG. 3B shows the FOMAT velocity plot of the third working embodiment of a spray polyurethane foam according to this present disclosure.

### DETAILED DESCRIPTION

The following disclosure encompasses various embodiments of low-density, high yield open-cell spray polyurethane foam compositions and methods in which those compositions can be manufactured and used. Such compositions may be the product of a reaction between polyols, amine catalysts, flame retardants, emulsifiers, polyisocyanates, and water, which may be carried out by spraying an isocyanate mixture and a resin mixture from a spraying system in an environment having an temperature ranging from 80 to 98 degrees Fahrenheit and a relative humidity of 30% or less. The resulting foam may have a density of no more than 0.5 pounds per cubic foot (pcf) and have a yield of at least 15,000 board feet per 50 gallons of a feed resin composition, or more preferably a density of no more than 0.4 pcf and a yield of at least 20,000 board feet per 50 gallons of the feed resin composition. These compositions may be applied such that they become embedded within the walls of a building so that the foam may prevent intrusion of water/moisture, sound, heat, and/or air from an external environment.

This description sets forth the functions and features of various embodiments of spray polyurethane foams, methods for the manufacture thereof, and methods of use thereof. It is to be understood, however, that the same or equivalent functions may be accomplished by different embodiments that are also intended to be encompassed within the scope of the present disclosure. It is further understood that the use of relational terms such as first and second and the like are used solely to distinguish one from another entity without necessarily requiring or implying any actual such relationship or order between such entities.

A spray polyurethane foam composition of the present disclosure may be obtained through the reaction of at least two mixtures. In particular, these mixtures may include an isocyanate mixture, which may be referred to as an “A-side” mixture, and a resin mixture, which may be referred to as a “B-side” mixture. These mixtures may be simultaneously applied upon a substrate and mixed with each other through the use of a spraying system; for instance, a plural component spray system may be used to separately store each mixture in a reservoir and spray each mixture in a 1:1 volume ratio upon a desired substrate. The isocyanate mixture may be composed of an isocyanate, such as methylene diphenyl diisocyanate (MDI), having a functionality ranging from 2.6 to 3.0. Suitable examples of isocyanates include Lupranate® M10 Isocyanate manufactured by BASF Polyurethanes and Wannate® PM200 manufactured by Wanhua Chemical.

As for the B-side, the resin mixture may be comprised of a polyol, an emulsifier, a flame retardant, a catalyst, a surfactant, and a blowing agent. In working embodiments, the resin mixture has been produced by first providing a mixture of polyols, an emulsifier, and a flame retardant and thereafter adding catalysts, surfactants, and water and thoroughly mixing. Adding the catalysts, surfactants, and water to an initial mixture of polyols, emulsifier, and flame retardant may be essential in obtaining a low-density product. The following paragraphs will describe the components which may make up the B-side resin mixture and the concentration they those components be present in the resin mixture; this concentration will be expressed as the part-by-weight of that particular component in the resin mixture. For example, if a given component's concentration could range from 10 to 20 parts-by-weight of a resin composition, then there could be 10 to 20 grams of that given component in a 100 gram sample of the resin mixture.

The polyol may be comprised of glycerin-based thiols, sucrose-based triols, diethanolamine-based triols, or combinations thereof. Working embodiments of the low-density, high-yield spray polyurethane foams of this present disclosure have been produced from resin mixtures having a total polyol concentration ranging from 14.5 parts-by-weight to 28 parts-by-weight of the resin mixture. If the polyol is composed of various, distinct types of polyol components, each polyol component may be present in a specified concentration. In certain embodiments, three types of polyol components can be present in a resin mixture, with a first polyol component ranging from 12 parts-by-weight to 18 parts-by-weight of the resin mixture, a second polyol component ranging from 2 parts-by-weight to 8 parts-by-weight of the resin mixture, and a third polyol component ranging from 0.5 parts-by-weight to 2 parts-by-weight of the resin mixture.

Preferably, the emulsifier would be comprised of nonylphenolethoxylates (NPEs), but any suitable emulsifier, including those conventionally used in the manufacture of spray polyurethane foams and suitable emulsifiers that are developed in the future, could be used. The emulsifier may range from 12 parts-by-weight to 20 parts-by-weight of the resin mixture. The flame retardant component may be comprised of any suitable flame retardant for use in spray polyurethane foams (including those currently known the art and later developed flame retardants), and it may range from 25 parts-by-weight to 30 parts-by-weight of the resin mixture.

The resin mixture's catalyst may be any catalyst recognized in the art, including those currently recognized and those later recognized in the future, as being suitable for polyurethane foam production. In particular, the catalyst may comprise reactive tertiary amine catalysts which facilitate the isocyanate-water-polyol reaction. Broadly speaking, the catalyst may be composed of amines, organometallic complexes, organic acid salts of metals, alkali metal salt compounds, and/or alkali metals. Particularly suitable amines include, but are not limited, to trialkylamines such as 2(2-Dimethylaminoethoxy)ethanol, N-Methyl-N—(N,N-dimethylaminoethyl)-aminoethanol, carboxylate salts of 1,1,3,3-Tetramethylguanidine, 1,1,3,3-Tetramethylguanidine, ester amines such as ethoxylamine, ethoxyldiamine, bis-(diethylethanolamine)adipate, 1,3,5-tris-(3-dimethylaminopropyl)-1,3,5-triazine, bis-(3-dimethylaminopropyl)methyl-amine, and bis(2-dimethylamino ethyl)ether, triethylenediamine, cyclohexylamine derivatives such as N,N-dimethylcyclohexylamine, morpholine derivatives such as N-methylmorpholine, piparazine derivatives such as N,N′-diethyl-2-methylpiparazine, N,N′-bis-(2-hydroxypropyl)-2-methylpiparazine, bis(2,21-dimethylaminoethyl)ether, amidines such as 1,8-diazabicycloundec-7-ene (DBU), and combinations thereof. Examples of specific alkali metal salt compounds include potassium acetate, potassium octoate, alkali metal carboxylates, metal alcoholoates, metal phenolates, metal hydroxides, quaternary ammonium salts, and combinations thereof. The total amount of catalyst in a resin mixture may range from 3.5 parts-by-weight to 11 parts-by-weight of the resin mixture. In certain embodiments, three types of catalyst components can be present in a resin mixture, with a first catalyst component ranging from 3 parts-by-weight to 8 parts-by-weight of the resin mixture, a second catalyst component ranging from 0.5 parts-by-weight to 2 parts-by-weight of the resin mixture, and a third catalyst component ranging from 0.2 parts-by-weight to 1 part-by-weight of the resin mixture. In certain preferred embodiments, at least one of the catalyst components of a resin mixture is composed of 1,1,3,3-Tetramethylguanidine, its carboxylate salts, or both at a concentration ranging from 0.2 parts-by-weight to 1 part-by-weight of the resin mixture.

The surfactant may be any suitable surfactant, although in preferred embodiments the surfactant is a silicone surfactant. A resin mixture may be comprised of a surfactant at a concentration ranging from 0.4 parts-by-weight to 1 part-by-weight of the resin mixture. Ideally, a resin mixture's blowing agent could be water. The blowing agent may range from 15 parts-by-weight to 20 parts-by-weight of the resin mixture.

With both isocyanate and resin mixtures provided and a spraying system ready to spray each mixture, the isocyanate and resin mixtures may be simultaneously sprayed upon a substrate. In order to produce a low-density, high-yield spray polyurethane foam according to this present disclosure, there are some operational parameters which may need to be fine-tuned. These operational parameters include a temperature of the resin mixture, a spraying pressure which the resin mixture and isocyanate mixture are ejected from the spraying system, the environmental conditions which the environment around the spraying system when the isocyanate and resin mixtures are sprayed out from the spraying system, and a thickness of the applied mixture. In particular, the resin mixture may have a temperature ranging from 125 to 135 degrees Fahrenheit, more preferably 130 to 135 degrees Fahrenheit, when being sprayed from the spraying system, and both resin and isocyanate mixtures can each independently be sprayed at a spraying pressure ranging from 800 psi to 1500 psi. As for environmental conditions, the spraying system may be in an environment having an ambient temperature ranging from 80 degrees to 98 degrees Fahrenheit, more preferably 85 to 98 degrees Fahrenheit, as this temperature range may create an optimal environment for foam formation. Additionally, this environment may have a relative humidity of 30% or less, more preferably a relative humidity ranging from 15% to 30%; maintaining this relative humidity may cause the resulting foam to have a low density while keeping a strong structural integrity. While it is contemplated that a spraying system could only need to be present in an environment having these temperature and humidity conditions at the during the period of time when the isocyanate and resin mixtures are sprayed out of the spraying system, it is further contemplated that the applied mixture may further be exposed to an environment having these temperature and humidity specifications while the applied mixture reacts and cures. The spraying system may apply the mixtures in a single pass such that the substrate receives a 2 to 6 inch, preferably a 3.5 to 6 inch, thick mixture.

The resulting foam may have various desirable properties, particularly with respect to the foam's density and yield. Specifically, the spray polyurethane foam may have a density of 0.5 pounds per cubic feet (pcf) or less, more preferably 0.45 pcf or less, and most preferably 0.4 pcf or less. Those skilled in the art are familiar that the efficiency of producing spray polyurethane foams can be measured as a yield in board feet per 50 gallons, with board feet equaling 1 square foot of the spray polyurethane foam at a 1 inch of thickness and 50 gallons referring to 50 gallons of both A-side and B-side mixtures (i.e., both a 50 gallon supply of A-side and a 50 gallon supply of B-side). The spray polyurethane foams of this present disclosure are capable of being produced at a yield of at least 15,000 board feet per 50 gallons, more preferably at least 18,000 board feet per 50 gallons, and most preferably at least 20,000 board feet per 50 gallons. The tensile strength of this foam may similarly have a desirable value of at least 3 psi, more preferably at least 4 psi, and most preferably at least 4.5 psi. The insulation capabilities of the foam may be quantified by calculating the R-value of a 1 inch sample of the foam, which may be at least 3.5, more preferably at least 4. As for protective properties, this foam may be effective at preventing air and water from permeating through the foam and could be fire resistant by having a flame spread index of no more than 25, more preferably no more than 15, and a smoke development index of no more than 400, more preferably no more than 350, and most preferably no more than 300. The foam may be applied upon a substrate such that the foam will become interposed between the external and internal walls of a building and can shield the internal environment defined by the building from the external environment surrounding the building. The various beneficial properties that these foams may obtain could result in the building's internal environment being shielded in a superior manner compared to spray polyurethane foams conventionally used in buildings.

The remaining disclosure will discuss a three working embodiment as well as various tests performed on those embodiments to illustrate the properties of the foams encompassed by this present disclosure. When relevant, reference will be made to the accompanying figures, which graphically show the results of certain tests.

The three embodiments were each prepared via a spray system applying an isocyanate mixture and a resin mixture upon a substrate. For each embodiment, the resin and isocyanate mixtures were sprayed at a spraying pressure ranging from 800 to 1500 psi while the spraying system was in an environment having an ambient temperature between 80 to 98 degrees Fahrenheit and a relative humidity ranging from 15% to 30%. The mixtures were sprayed such that a 2-6 inch mixture was applied on the substrate in a single pass. The first of these embodiments differs from the other two embodiments in that its initial resin mixture had a different component composition; specifically the first embodiment included 1,1,3,3-tetramethylguanidine and its carboxylate salts as a catalyst while the other embodiments did not. The compositions of each resin mixture are provided in tables 1-3 below, with table 1 corresponding to the embodiment having a different resin mixture component composition than the resin mixture compositions of the other two embodiments shown in tables 2 and 3.

TABLE 1

| Component | Concentration (parts-by-weight) |
|---|---|
| Polyether polyol 1 | 12-18 |
| Polyether polyol 2 | 2-8 |
| Polyether polyol 3 | 0.5-2 |
| Emulsifier | 12-20 |
| Flame retardant | 25-30 |
| Silicone surfactant | 0.4-1 |
| Reactive amine catalyst 1 | 3-8 |
| Reactive amine catalyst 2 | 0.5-2 |
| 1,1,3,3-tetramethylguanidine and its | 0.2-1 |
| carboxylate salts (catalyst 3) | |
| Water | 15-20 |

TABLE 2

| Component | Concentration (parts-by-weight) |
|---|---|
| Polyether polyol 1 | 12-18 |
| Polyether polyol 2 | 2-8 |
| Polyether polyol 3 | 0.5-2 |
| Emulsifier | 12-20 |
| Flame retardant | 25-30 |
| Silicone surfactant | 0.4-1 |
| Reactive amine catalyst 1 | 3-8 |
| Reactive amine catalyst 2 | 0.5-2 |
| Water | 15-20 |

TABLE 3

| Component | Concentration (parts-by-weight) |
|---|---|
| Polyether polyol 1 | 12-18 |
| Polyether polyol 2 | 2-8 |
| Polyether polyol 3 | 0.5-2 |
| Emulsifier | 12-20 |
| Flame retardant | 25-30 |
| Silicone surfactant | 0.4-1 |
| Reactive amine catalyst 1 | 3-8 |
| Reactive amine catalyst 2 | 0.5-2 |
| Water | 15-20 |

The first and second embodiments obtained yields ranging from 21,000 to 23,000 board feet per 50 gallons, while the third embodiments obtained a yield ranging from 16,000 to 18,000 board feet per 50 gallons.

Table 4 below shows various physical properties of each working embodiment of the spray polyurethane foams, with embodiment 1, 2, and 3 corresponding to the foams made from the resin mixtures described above in tables 1, 2, and 3 respectively. Each test was performed according to tests prescribed by the American Society for Testing and Materials (ASTM), with the particular ASTM test performed shown in the second column from the left.

TABLE 4

| Physical Test | ASTM | Embodiment 1 | Embodiment 2 | Embodiment 3 |
|---|---|---|---|---|
| Core Density | ASTM D1622 | 0.38 pounds/cubic | 0.48 ± 0.05 | 0.5 ± 0.05 |
| | | foot | pounds/cubic foot | pounds/cubic foot |
| Tensile Strength | ASTM D1623 | 4.49 psi | 5 psi | 3.35 psi |
| R-Value at 1 inch | ASTM C518 | 4.01 | 3.8 | 4.2 |
| Air permeance at | ASTM E2187 at 75 | 0.010 | 0.00431 | 0.00431 |
| 3.5 inches | PA | | | |
| Water Vapor | ASTM E96 | 16 perms at 2 inches | 9 perms at 2 inches | 8.4 perms at 2 |
| Permeance | | | | inches |
| Dimensional | ASTM D2126 | Less than 9.2% | Less than 14.7% | Less than 3.8% |
| Stability | | | | |
| Flammability | ASTM E84 at 4 | 20 flame spread | 15 flame spread | 15 flame spread |
| | inches | index, 350 smoke | index, 200 smoke | index, 200 smoke |
| | | development index | development index | development index |

The reactivity of these 3 embodiments were measured using FOMAT® Foam Qualification System provided by Farmat Messtechnik GmbH. In particular, the time needed for a foam to rise to a certain height relative to its final height, the maximum velocity of height increase, the final height, shrinkage, and shrinkage ratios were measured, all of which are provided in Table 5 below.

TABLE 5

| Foamat | | | | |
|---|---|---|---|---|
| Measurements | — | Embodiment 1 | Embodiment 2 | Embodiment 3 |
| Choice Citeria 1 [s] | 15.0% R | 6.68 | 6.87 | 5.38 |
| Choice Citeria 2 [s] | 80.0% R | 9.31 | 9.56 | 7.71 |
| Rise Time [s] | 98.0% R | 10.81 | 11.18 | 9.23 |
| Max Velocity | | 48.48 | 51.33 | 71.93 |
| [mm/s] | | | | |
| Final Height [mm] | | 200 | 190.15 | 204.02 |
| Shrinkage [mm] | | 5.57 | 5.71 | 8.41 |
| Shrinkage Ratio | | 0.03387 | 0.030028925 | 0.039898049 |

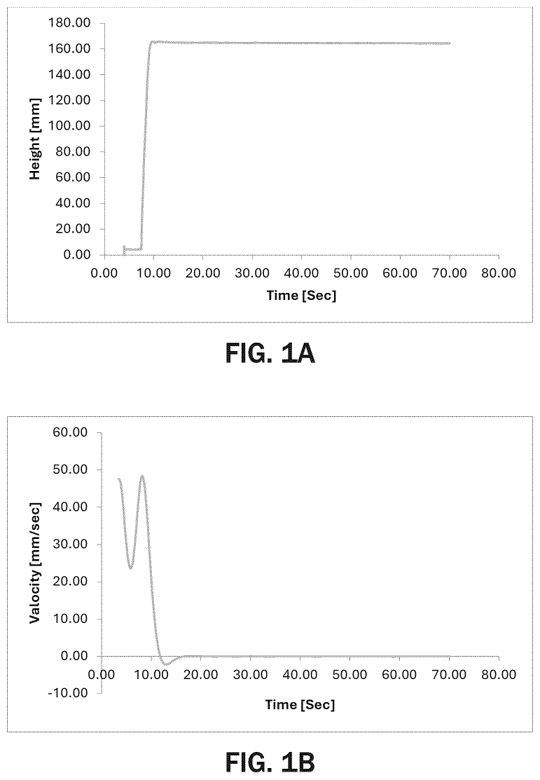

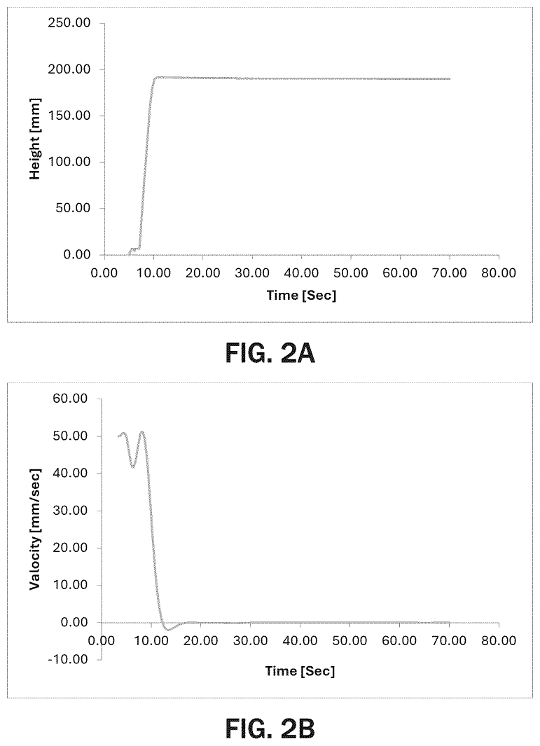

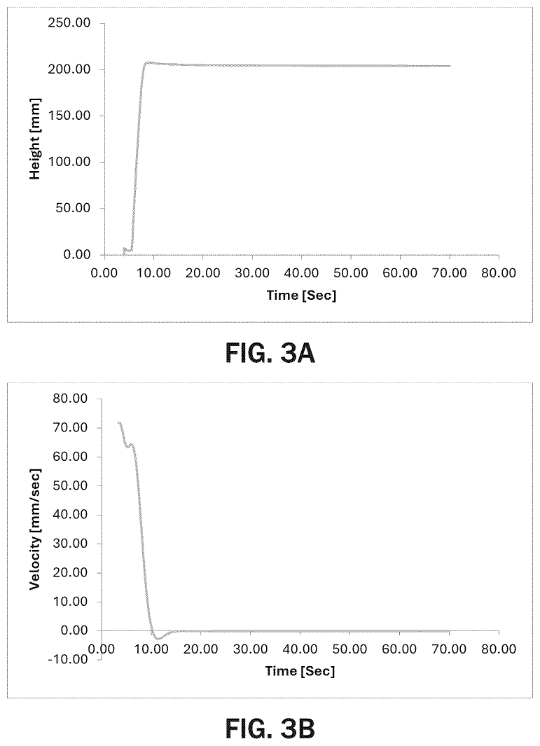

Further results from the FOMAT® measurements described above in relation to Table 5 are provided in the accompanying figures. In particular, FIGS. 1A and 1B show the change in height and velocity respectively of the first embodiment of the spray polyurethane foam, while FIGS. 2A and 2B do the same for the second embodiment and FIGS. 3A and 3B do the same for the third embodiment.

The above description is given by way of example, and not limitation. Given the above disclosure, one skilled in the art could devise variations that are within the scope and spirit of this disclosure. Further, the various features of the embodiments disclosed herein can be used alone, or in varying combinations with each other and are not intended to be limited to the specific combination described herein. Thus, the scope of the claims is not to be limited by the illustrated embodiments. Additional modifications and improvements of the present disclosure may also be apparent to those of ordinary skill in the art. Thus, the particular combination of parts and steps described and illustrated herein is intended to represent only certain embodiments of the present subject matter and is not intended to serve as limitations of alternative devices and methods within the spirit and scope of this disclosure.

What is claimed is:

1. A method of producing a spray polyurethane foam, the method comprising the steps of:
providing an isocyanate mixture comprising an isocyanate;
providing a resin mixture comprising a polyol, a catalyst, an emulsifier, a flame retardant, and a blowing agent;
spraying the isocyanate mixture and the resin mixture with a spraying system such that the isocyanate mixture and the resin mixture are applied upon a substrate to form an applied mixture, the resin mixture being at a temperature ranging from 125 to 135 degrees Fahrenheit when being sprayed; and
allowing the applied mixture to cure to form the spray polyurethan foam;
wherein during said step of spraying the isocyanate mixture and the resin mixture, the spraying system is in an environment having an ambient temperature ranging from 80 to 98 degrees Fahrenheit and a relative humidity of 30% or less.

2. The spray polyurethane form produced by the method of claim 1.

3. The method of claim 1, wherein the isocyanate comprises methyl diphenyl diisocyanate (MDI).

4. The method of claim 1, wherein the isocyanate has a functionality ranging from 2.6 to 3.0.

5. The method of claim 1, wherein the polyol comprises glycerin-based triols, sucrose-based triols, diethanolamine-based triols, or combinations thereof.

6. The method of claim 1, wherein the polyol is present in the resin mixture at a concentration ranging from 12 parts-by-weight to 18 parts-by-weight of the resin mixture.

7. The method of claim 1, wherein the emulsifier comprises a nonylphenolethoxylate (NPE).

8. The method of claim 1, wherein the emulsifier is present in the resin mixture at a concentration ranging from 12 parts-by-weight to 20 parts-by-weight of the resin mixture.

9. The method of claim 1, wherein the flame retardant is present in the resin mixture at a concentration ranging from 25 parts-by-weight to 30 parts-by-weight of the resin mixture.

10. The method of claim 1, wherein the catalyst comprises an amine, an organometallic complex, an organic acid salt of a metal, an alkali metal salt compound, an alkali metal, or combinations thereof.

11. The method of claim 10, wherein the amine comprises 2(2-Dimethylaminoethoxy)ethanol, N-Methyl-N—(N,N-dimethylaminoethyl)-aminoethanol, carboxylate salts of 1,1,3,3-tetramethylguanidine, 1,1,3,3-tetramethylguanidine, ethoxylamine, ethoxyldiamine, bis-(diethylethanolamine)adipate, 1,3,5-tris-(3-dimethylaminopropyl)-1,3,5-triazine, bis-(3-dimethylaminopropyl)methyl-amine, bis(2-dimethylamino ethyl)ether, triethylenediamine, N,N-dimethylcyclohexylamine, N-methylmorpholine, N,N′-diethyl-2-methylpiparazine, N,N′-bis-(2-hydroxypropyl)-2-methylpiparazine, bis(2,21-dimethylaminoethyl)ether, 1,8-diazabicycloundec-7-ene (DBU), or combinations thereof.

12. The method of claim 10, wherein the alkali metal salt compounds comprises potassium acetate, potassium octoate, alkali metal carboxylates, metal alcoholoates, metal phenolates, metal hydroxides, quaternary ammonium salts, or combinations thereof.

13. The method of claim 1, wherein the catalyst is present in the resin mixture at a concentration ranging from 3.5 parts-by-weight to 11 parts-by-weight of the resin mixture.

14. The method of claim 1, wherein the catalyst comprises 1,1,3,3-tetramethylguanidine, one or more carboxylate salts of 1,1,3,3-tetramethylguanidine, or both at a concentration in the resin mixture ranging from 0.2 parts-by-weight to 1 part-by-weight of the resin mixture.

15. The method of claim 1, wherein the blowing agent is present in the resin mixture at a concentration ranging from 15 parts-by-weight to 20 parts-by-weight of the resin mixture.

16. The method of claim 1, wherein during said step of spraying the isocyanate mixture and the resin mixture, the isocyanate mixture and the resin mixture are each independently sprayed at a spraying pressure ranging from 800 psi to 1500 psi.

17. The method of claim 1, wherein during said step of spraying the isocyanate mixture and the resin mixture, the isocyanate mixture and the resin mixture are applied in a single pass such that the applied mixture has a thickness ranging from 2 to 6 inches.

18. The method of claim 1, wherein the spray polyurethane foam has a density of 0.5 pounds per cubic foot or less.

19. The method of claim 1, wherein the spray polyurethane foam has a tensile strength of at least 3 psi.

20. The method of claim 1, wherein the spray polyurethane foam has an R-value at 1 inch of at least 3.5.
